(19) United States
(12) Patent Application Publication
(10) Pub. No.: US 2002/0131773 A1
(43) Pub. Date: Sep. 19, 2002

(54) System and method for remote image centering

(76) Inventor: Lawrence R. Bigler, Windsor, CO (US)

Correspondence Address: HEWLETT-PACKARD COMPANY, Intellectual Property Adminisration, P.O. Box 272400, Fort Collins, CO, 80527-2400, US

(21) Appl. No.: 09/811,175

(22) Filed: Mar. 16, 2001

(51) Int. Cl. G03B 17/00

(52) U.S. Cl. 396/58

(57) ABSTRACT

The present invention is a system and method which allows a camera to be pre-positioned at a given location and the field of view adjusted on a picture by picture basis such that the subject of the picture is centered within the field of view and such that the focal length of the camera lens is optimal for the particular picture. Using this system and method a movable sensor would be positioned at the image to be captured and the camera would effectively swivel to align itself with that trigger based upon translation of signals received from that trigger. Additionally, information obtained from the movable trigger may be used to adjust its field of view via optical and/or digital zoom.

### BACKGROUND

Today it is common to position a camera at a particular location and focus the camera on a certain field of view. Certain remote triggers then may be employed to activate the camera to record the image or images within that field of view. The camera could be a still camera or a continuous frame camera, (such as a video camera). These triggers could, for example, be movement within a certain area, a signal sent by a user (either wireline or wireless) or by the tripping of a pressure sensitive switch, or the trigger could even be periodically timed.

The problem with these systems is that the camera is pre-framed on a certain field of view and unless the desired subject is within that field of view the resulting picture will not necessarily capture the proper subject. There is nothing available today that will automatically center the image with respect to the camera's field of view or adjust the field of view so that the desired image is centered and appropriately scaled in the resulting picture. Thus, these cameras do not know where the remote signal is coming from and thus can not center or size the desired image.

One example would be at a reception where still pictures are taken frame by frame and where the camera is equipped to respond to a signal from a mobile user. As technology exists today the subjects of each frame would have to be brought to, and centered within, the field of view of the camera and then the user would activate the remote signal to capture the desired image. Even when doing this, the user takes a risk that the subjects are not properly centered and that the field of view will be slightly wrong.

### SUMMARY OF THE INVENTION

The present invention is directed to a system and method which allows a camera to be propositioned at a given location and the field of view adjusted as each picture is taken so that the subject of the picture is centered within the field of view and such that the focal length of the camera lens is optimal for the particular picture. Using this system and method, a movable trigger would be positioned at the image to be captured and the camera (or the field of view of the camera) would effectively swivel to align itself with that trigger. The camera then would adjust its focal length to center on the sensor (if that is the focal length desired) and upon a proper signal from the trigger, the camera would operate to capture the desired image. If the user desired, he/she could adjust the camera zoom to always have roughly the same size picture independent of whether the image were close to or far from the camera. The camera recognizes where the remote control is located and uses the information from the remote control to control the resulting image. This control, for example, could be focus, centering, f-stop, etc. or such settings could be left to automated default settings.

The movement of the camera could, in one embodiment, be a swivel built into the camera (such as a swivel on its base, or even a lens swivel) or it could be a swivel on a tripod. The camera also could be equipped with a digitally directive lens that would allow the lens itself to change its focal asmuth or change its focal horizontal direction.

### BRIEF DESCRIPTION OF THE DRAWING

FIG. 1 shows a camera equipment with the invention, which camera is mounted to a tripod;

FIG. 2 shows a block diagram of one embodiment of a memory and processor for controlling the operation of the system and method of this invention; and

FIG. 3 shows a typical image to captured by the camera of FIG. 1 under control of a remote mobile activation device.

### DETAILED DESCRIPTION

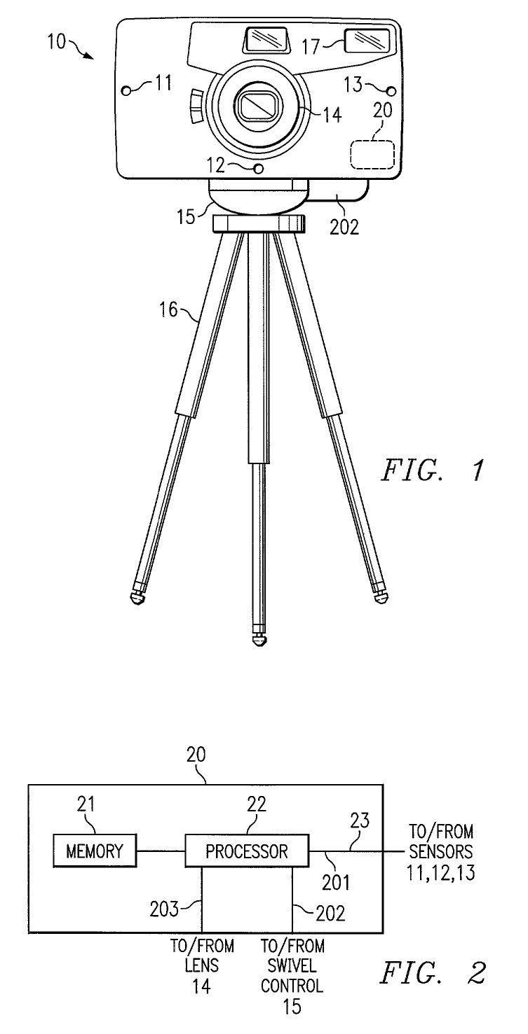

FIG. 1 shows camera 10 having lens 14, optional flash element 17 and a plurality (in this embodiment 3) sensors 11, 12, and 13. Internal to camera 10 (and discussed in more detail with respect to FIG. 2) is memory and processor unit 20. Camera 10, in this embodiment, sits atop tripod 16 and is connected to tripod 16 by rotations assembly 15. Rotation assembly takes its rotation instructions from processor unit 20 via cable 202. This rotation can be a combination of left/ right (horizontal) and up/down (asmithal). Lens 14 is designed to have its focal length and its f-stop changed by signals coming from processor unit 20, as will be discussed.

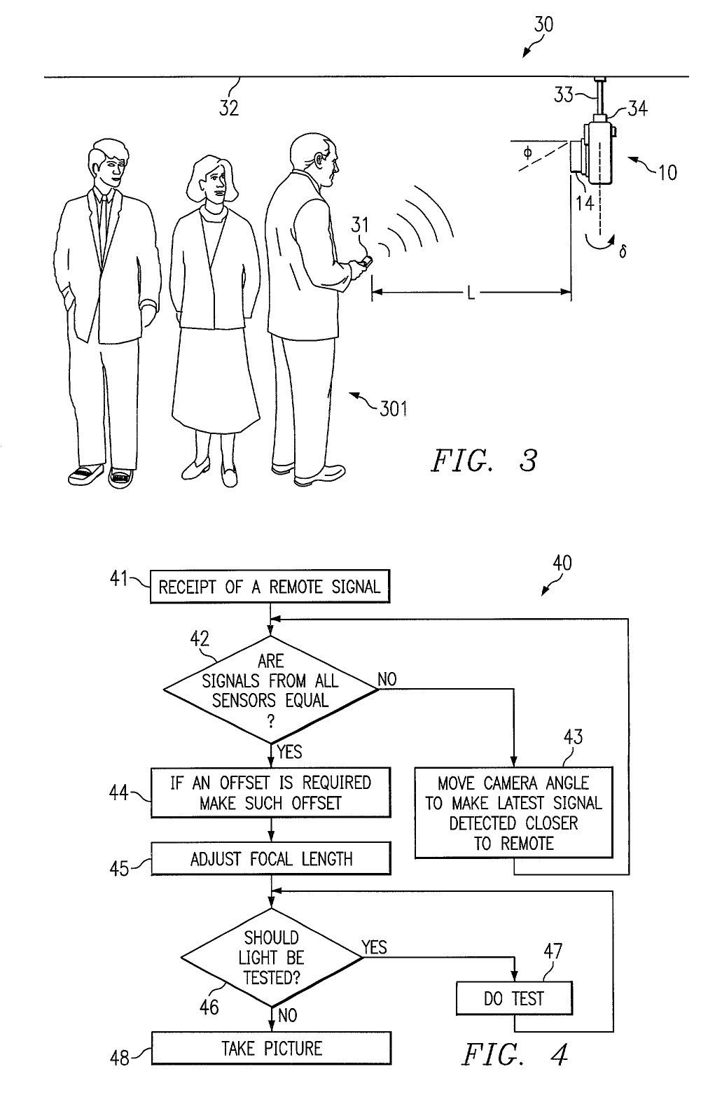

In operation, a remote device, such as device 31 (FIG. 3) is activated by a user from any location where an image is desired to be captured. Device 31 sends a signal, (IR, RF, or otherwise) which is captured by sensors 11, 12 and 13 (or more if desired). The direction to point lens 14 can be calculated in terms of left/right, up/down.

One method of adjusting camera 10 could be for the camera to begin its field of view adjustment and continue doing so until the signal received by all three sensors was equal. This operation is discussed with respect to FIG. 4.

In addition to activating and guiding the directional orientation of the camera, the trigger signal sent by the remote control could also be used to adjust the framing or field of view of an image. (This would be accomplished in coordination with the camera's auto-focus algorithms.) One method would be for the camera to identify the location of the sensor and adjust the orientation. Upon completion of this task, the camera would conduct an auto-exposure and auto-focus routine. When the subject distance was determined, the camera zoom (optical or digital) would be employed to adjust the effective field of view. Such adjustment would allow the user to take full advantage of the imaging sensor's resolution by avoiding image capture of none-valued peripheral scenery.

The sensors would be placed on the camera face, or other location, such that the system would be able to determine from signal timing differences, how the camera should be adjusted.

In the embodiment shown, rotation assembly 15 would be a hemispherical type—two-axis motor-control type of mechanism that moves camera 10 up/down, left/right. This would be typical for film type cameras and cameras with rigidly mounted electronic image capture sensor. However, due to the integral nature of lens and capture devices in digital imaging CCD and CMOS based digital image, digital imaging camera can more easily have their lens swivelled and thus the actual lens control for digital imaging devices can be directly at the lens/capture device assembly (not shown).

In both situations (film or digital) the swivel device can be added to the camera or built into the camera.

FIG. 2 shows a block diagram of processor unit 20 which contains memory 21 and processor 22. Processor 22 communicates with sensors 11, 12 and 13 via cable 201; and with swivel control 15 via cable 202 and with lens 14 via cable 203. Of course, any or all of these communication channels could also be wireless and unit 20 could be mounted within camera 10 or as an add on thereto or in a separate device such as a computer or personal assistant device.

FIG. 3 shows one use of the adjustable focus camera at a reception where remote device 31 is carried on the person (in a hand or pocket) of a user who is positioning a group of people to form a desired image for capturing by camera 10, which, in this figure, is hung from ceiling 32 by bracket 33. In this embodiment, swivel control unit 34 is mounted above camera 10.

When device 31 is activated (assuming that it is not always being activated which is possible if the user desires the camera to follow him/her where ever he/she walks) a signal, which preferably is RF, but could be IR or any other signal type, the signals are picked up by the sensors on camera 10 and, the process of orienting the camera begins.

FIG. 4, system 40 shows one such process, as controlled by unit 20 (FIG. 2). Box 41 receives a remote signal and process 42 checks to see if the framing or field of view is proper. This is done, in one embodiment, by checking the signal timing from all sensors, based on the assumption that when the timing of the signal from the remote device is equal at all sensors the lens will be properly positioned with respect to the remote trigger and subject. If process 42 finds uneven signals then process 43 determines which sensor is further away (slowest signal to reach it, or weakest signal if signal strength is the measure) and sends a signal, for example, via cable 203, (FIG. 2) to lens 14 (or to rotation assembly 15) so that the lens (or camera) will swivel toward the remote signal.

As shown in FIG. 3, in this manner angle theta is hanging and length L is being calculated.

Continuing in FIG. 4, process 42 is again checked and this continues until it is determined that the camera is properly oriented.

Process 44 then, if desired, changes the field of view of the lens (or the camera) so that any desired directional offset is taken into account. The system could be designed to take into account that the sensor will be always be, say 2 feet to the left of the picture center focus point, or 2 feet below such focus point. This would allow a user (such as the photo taker at the reception) to position the subjects properly and yet remain out of the picture him/her self. The camera could be equipped with a control (not shown) to provide instructions to processor 20 for such offset. In one embodiment, a dial could be used with numbers corresponding to left/right, up/down that the user could enter. In an alternate embodiment, the offset could come in the signal from remote device 31, again being set by the user.

Then focal length L is tested. If necessary, focal length L is adjusted (process 45) and light tests, if desired, are performed (processes 46 and 47). At this point the picture is taken (process 48). The present invention may operate to automatically take the picture upon detection of the remote orientation signals. Also, the present invention may operate to take the picture upon receipt of a separate control signal.

What is claimed is:

1. A method for controlling the focal point of an image capturing device, said method comprising the steps of:
receiving at said image capturing device signals from a location remote source;
processing received ones of said signals to determine a subject distance to be captured by a lens of said image capturing device; and
adjusting, if necessary, the angle of said lens with respect to said location of said remote source in accordance with processed ones of said received signals.

2. The method of claim 1 wherein said remote source is movable from time to time.

3. The method of claim 1 further including the step of
enabling said image capturing device to capture said image to be captured based, in part upon processed ones of said signals.

4. The method of claim 1 wherein said adjusting step includes the step of incorporating an offset into said angle of said lens.

5. The method of claim 1 wherein said method is controlled by processing within said image capturing device.

6. The method of claim 1 wherein said lens angle is controlled by the rotation of the image capturing device.

7. The method of claim 1 wherein said lens angle is controlled by the rotation of the lens.

8. A device capturing images, said device comprising:
means for receiving at said image capturing device signals from a remote source;
means for processing received ones of said signals to determine subject distance for an image to be captured by a lens of said image capturing device; and
means for adjusting, if necessary, the angle of said lens with respect to said location of said remote source in accordance with processed ones of said received signals.

9. The device of claim 8 further including:
means for enabling said image capturing device to capture said image to be captured based, in part, upon processed ones of said signals.

10. The device of claim 8 wherein said adjusting means includes means for incorporating an offset into said angle of said lens.

11. The device of claim 8 wherein said processing occurs within said image capturing device.

12. The device of claim 8 further including means operable under control of said adjusting means for rotating said image capturing device.

13. The device of claim 8 further including means operable under control of said adjusting means for rotating said lens independent from said image capturing device.

14. A device capturing images, said device comprising:
at least one sensor for receiving at said image capturing device signals from a location remote source; and
a processor for adjusting, if necessary, the angle of a lens of said image processing device with respect to said location of said remote source in accordance with processed ones of said received signals.

15. The device of claim 14 further including:
an image capturing element operational for capturing said image to be captured based, in part, upon processed ones of said signals.

16. The device of claim 14 wherein any said adjustment incorporates an offset.

17. The device of claim 14 wherein any said adjustment rotates said image capturing device.

18. The device of claim 14 wherein any said adjustment rotates said lens independent from said image capturing device.

19. A device for attachment to an image capturing system, said device comprising:
means for receiving signals from a remote source;
means for processing received ones of said signals to determine subject distance for an image to be captured by said image capturing device; and
means for adjusting, if necessary, the angle of said image capturing device with respect to said location of said remote source in accordance with processed ones of said received signals.

20. The device of claim 19 further including:
means for enabling said image capturing device to capture images based, in part, upon processed ones of said signals.
